(19) United States
(12) Patent Application Publication
(10) Pub. No.: US 2007/0179982 A1
(43) Pub. Date: Aug. 2, 2007

(54) Temporal summarization of a data subset

(75) Inventor: William S. Spangler, San Martin, CA (US)

Correspondence Address: FREDERICK W. GIBB, III;Gibb & Rahman, LLC, 2568-A RIVA ROAD, SUITE 304, ANNAPOLIS, MD, 21401, US

(73) Assignee: International Business Machines Corporation, Armonk, NY (US)

(21) Appl. No.: 11/344,303

(22) Filed: Jan. 31, 2006

(51) Int. Cl. G06F 17/30

(52) U.S. Cl. 707/200

(57) ABSTRACT

A relational database system and method to perform a method of temporal summarization of a data set comprising data that are initially unevenly distributed with respect to a period of time in the set and have attributed data categories and dates, wherein the method comprises creating N different buckets in a hashing table, wherein each of the buckets comprises a substantially same number of data elements, wherein each of the data elements uniquely corresponds with a particular bucket, and wherein each of the buckets corresponds with a unique time period; and plotting, for each data category, a number corresponding to the number of data elements in the data category, as a function of the time periods corresponding to the N different buckets. The method may also comprise plotting respective line graphs corresponding to the plotted number of data elements, wherein each line graph corresponds with a particular data category.

### BACKGROUND

1. Technical Field

The embodiments herein generally relate to computer systems, and, more particularly, to techniques for text trending and data clustering in database management systems.

2. Description of the Related Art

Businesses have been able to systematically increase the leverage gained from enterprise data through technologies such as relational database management systems and techniques such as data warehousing. Additionally, those in the industry have conjectured that the amount of knowledge encoded in electronic text far surpasses that available in data alone. However, the ability to take advantage of this wealth of knowledge is just beginning to meet the challenge. One important step in achieving this potential has been to structure the inherently unstructured information in meaningful ways. A well-established first step in gaining understanding is to segment examples into meaningful categories. This leads to the idea of taxonomies, which are natural hierarchical organizations of the information in alignment with the business goals, organization, and processes of a particular entity.

Past approaches to summarizing temporal data have focused on absolute graphs of data using one or more “trend” lines. Unfortunately, these approaches tend to require that the temporal scale of the data be relatively constant across different analyses. Accordingly, there remains a need for a new technique of temporal summarization of a data subset in a database management system.

### SUMMARY

In view of the foregoing, an embodiment provides a method and program storage device readable by computer, tangibly embodying a program of instructions executable by the computer to perform a method of temporal summarization of a data set comprising data that are initially unevenly distributed with respect to a period of time in the set and have attributed data categories and dates, wherein the method comprises creating N different buckets in a hashing table, wherein each of the buckets comprises a substantially same number of data elements, wherein each of the data elements uniquely corresponds with a particular bucket, and wherein each of the buckets corresponds with a unique time period; and plotting, for each data category, a number corresponding to the number of data elements in the data category, as a function of the time periods corresponding to the N different buckets. The method may further comprise plotting respective line graphs corresponding to the plotted number of data elements, wherein each line graph corresponds with a particular data category. Additionally, the method may further comprise computing a representative time for each of the data categories by calculating an average time of data elements in a particular data category. Moreover, the method may further comprise displaying, for at least one of the data categories, pairs of line graphs and corresponding representative times of the pairs of line graphs. Preferably, N is at least 3. Also, the number of data elements in the different buckets preferably differ from each other by no more than one.

Another embodiment provides a method of performing temporal summarization of a data set comprising timestamps corresponding to dates of data elements in the data set, wherein the method comprises sorting the timestamps in chronological order; dividing the timestamps into N contiguous buckets of substantially equal size; counting, for each of the N contiguous buckets, how many data elements belong to a particular bucket; calculating an average date of the data elements in the data set; plotting numeric values corresponding to the data elements in each of the N contiguous buckets; and combining the calculated average date and the plotted numeric values to describe the data set. The method may further comprise plotting respective line graphs corresponding to the plotted numeric values, wherein each line graph corresponds with a particular data set. Additionally, the method may further comprise computing a representative time for each data set by calculating an average time of the data elements corresponding with a particular data set. Also, the method may further comprise displaying, for at least one of the data sets, pairs of the line graphs and corresponding representative times of the pairs of the line graphs. Preferably, N is at least 3. Furthermore, the substantially equal size preferably comprises a substantially same number of data elements in different ones of the N contiguous buckets, wherein the number of data elements in the different buckets preferably differ from each other by no more than one.

Another embodiment provides a relational database system for temporal summarization of a data set comprising data that are initially unevenly distributed with respect to a period of time in the set and have attributed data categories and dates, wherein the relational database system comprises a hashing table comprising N number of different buckets, wherein each of the buckets comprises a substantially same number of data elements, wherein each of the data elements uniquely corresponds with a particular bucket, and wherein each of the buckets corresponds with a unique time period; and a plotter adapted to plot, for each data category, the number of data elements corresponding with the data category as a function of a plurality of time periods defined by the N number of different buckets. Preferably, the plotter is adapted to plot respective line graphs corresponding to the plotted number of data elements, wherein each line graph corresponds with a particular data category. Also, the relational database system may further comprise a computer adapted to compute a representative time for each of the data categories by calculating an average time of data elements in a particular data category. Additionally, the relational database system may further comprise a display unit adapted to display, for at least one of the data categories, pairs of line graphs and corresponding representative times of the pairs of line graphs. Preferably, N is at least 3. Furthermore, the number of data elements in the different buckets preferably differ from each other by no more than one.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIGS. 1(A) and 1(B) are flow diagrams illustrating preferred methods according to an embodiment herein;

FIGS. 2(A) through 2(D) are graphical representations comparing a conventional process and a process according to an embodiment herein;

FIGS. 3(A) and 3(B) are graphical representations illustrating example implementations of the embodiments herein;

FIG. 4 illustrates a schematic diagram of a relational database system according to an embodiment herein; and

FIG. 5 illustrates a computer system diagram according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

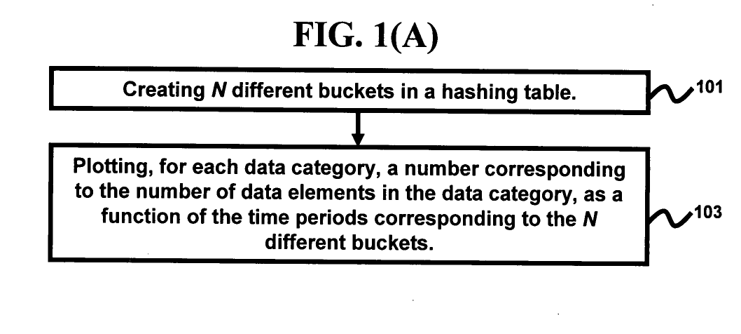

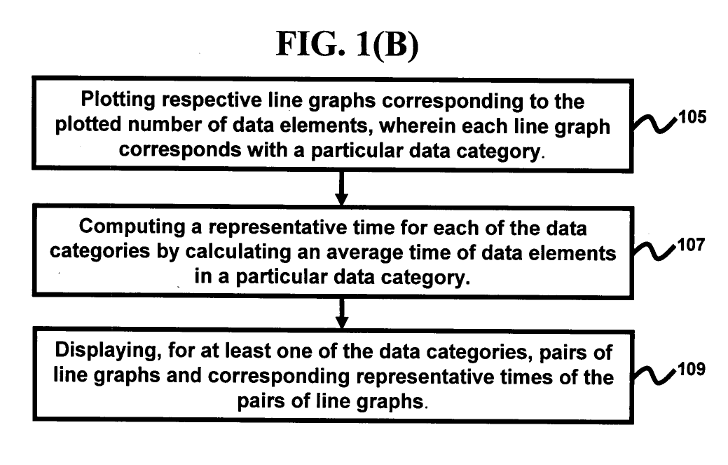

As mentioned, there remains a need for a new technique of temporal summarization of a data subset in a database management system. The embodiments herein achieve this by providing a temporal summarization technique that creates two distinct descriptive elements, for a data subset, that complement each other. Referring now to FIGS. 1(A) through 5, where similar reference characters denote corresponding features consistently throughout the figures, there are shown preferred embodiments.

In the context of the embodiments herein, summarization is the process of providing a statistic, graphic, or short description that captures the most salient features of a collection of data elements. An example of a metric that summarizes data comprising a set of integers would be the average and standard deviation of that set. The embodiments herein provide a summarizing description for a set of timestamps (e.g., dates) pulled without replacement from a larger set. In other words, the timestamps of a subset of the original data are summarized.

Specifically, the embodiments herein summarize temporal data by creating two distinct descriptive elements that complement each other. One element is an “average” date that serves to anchor the data in time, and the second element is a “relative” line graph that serves to show the overall relationship between the subset and the larger set over time. The embodiments herein combine these two elements into a single display graphic that does not require any a priori assumptions about time scale. This allows for a much smaller scaled representation of the summary (e.g., as an icon). More particularly, the embodiments herein focus on the visualization, editing, and validation of clustering results. Clustering is one possible way that categories may be created over a set of examples.

FIG. 1(A) is a flow diagram according to an embodiment herein illustrating a method of temporal summarization of a data set comprising data that are initially unevenly distributed with respect to a period of time in the set and have attributed data categories and dates, wherein the method comprises creating (101) N different buckets in a hashing table, wherein each of the buckets comprises a substantially same number of data elements, wherein each of the data elements uniquely corresponds with a particular bucket, and wherein each of the buckets corresponds with a unique time period; and plotting (103), for each data category, a number corresponding to the number of data elements in the data category, as a function of the time periods corresponding to the N different buckets. Preferably, N is at least 3. Also, the number of data elements in the different buckets preferably differ from each other by no more than one.

As illustrated in FIG. 1(B), the method may further comprise plotting (105) respective line graphs corresponding to the plotted number of data elements, wherein each line graph corresponds with a particular data category. Additionally, the method may further comprise computing (107) a representative time for each of the data categories by calculating an average time of data elements in a particular data category. Moreover, the method may further comprise displaying (109), for at least one of the data categories, pairs of line graphs and corresponding representative times of the pairs of line graphs.

Furthermore, the embodiments herein may also be applied to any situation where one desires to summarize the relative trend of data over time. Accordingly, the embodiments herein may be used to create tables (i.e., spreadsheets) that illustrate the value of each variable or combination of variables with a summarization average and trend line.

The steps of constructing temporal summarizations using the embodiments herein are as follows: given a set of timestamps, D, and a set of subset, d:

(1) Sort the D timestamps into chronological order. Manners of sorting are well-known to those skilled in the art.

(2) Divide the D timestamps into N contiguous buckets of substantially equal size. The number of buckets may be increased to divide the D timestamps (i.e., data elements) into equally-sized buckets. Alternatively, the buckets may be substantially equal in size with the difference in the sizes of the buckets dependent on the data set. An acceptable difference in size may be expressed as a percentage tolerance corresponding to the size of the data set in which the sizes of the buckets differ by no more than 10% and, more preferably, by less than 1%. Alternatively, if the size of the data set is M (the total number of data elements), then the percentage tolerance may be expressed as 1/M. For example, if M equals 10, then substantially equal size may refer to a percentage tolerance in which the sizes of the buckets differ by no more than 10%. Alternatively, substantially equal size may refer to an actual number such as a same number of data elements plus or minus one data element (i.e., within a tolerance of 1). For example, if there are 10 data elements to split in 3 “substantially equal” buckets, then one of the buckets would have 4 elements and the other two buckets would have 3 elements.

(3) For each of the N buckets, count the number of elements of d that belong to that bucket.

(4) Convert each date in d into an integer (e.g., by counting seconds from some fixed point in time) and calculate the average over d. Convert this average back into a date using the reverse process. This is the “average” date.

(5) Plot, in the fashion of a line graph, the values for each of the counts of d in each of the N buckets.

(6) Display the line graph and the “average” date as the summary description of the subset d.

The above steps may be implemented, for example, using computer-enabled software code such as further detailed below. The number of N buckets is variable to suit the level of granularity required for the analyses. For example, N could be as small as 2 and as large as the data set itself divided by the number of data elements needed to make each bucket statistically meaningful. In one embodiment, N is at least 3.

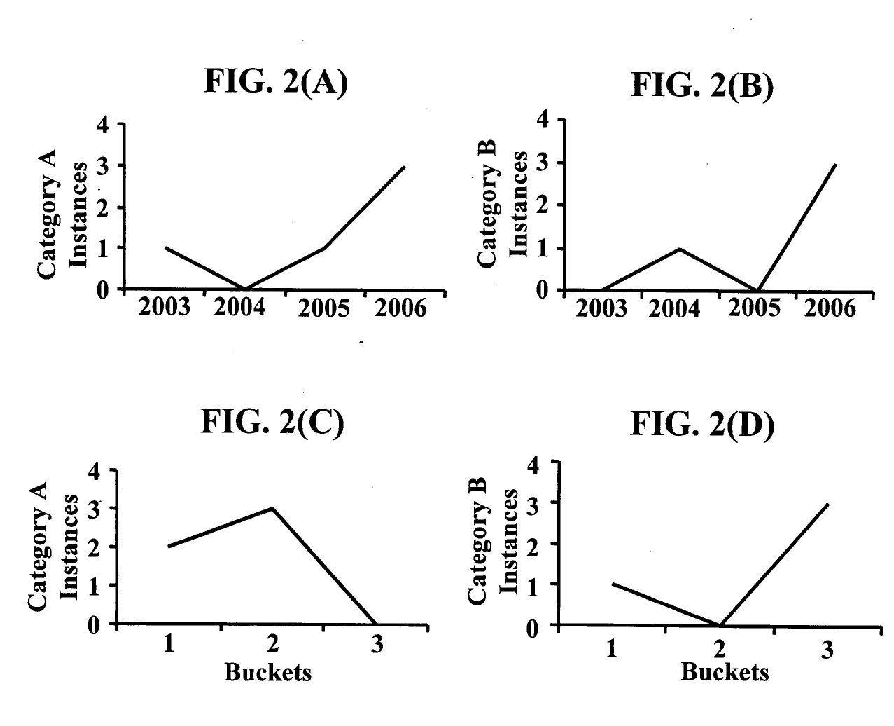

FIGS. 2(A) through 2(D), with respect to the data provided in Table 1, illustrate the difference between a conventional trend chart (FIGS. 2(A) and 2(B)) of two categories (Category A and Category B) and a trend chart using the embodiments herein (FIGS. 2(C) and 2(D)).

TABLE 1
Trend Data

| Date | Category | Bucket |
|---|---|---|
| Jan. 01, 2003 | A | First |
| Jan. 05, 2004 | B | First |
| Jan. 08, 2005 | A | First |
| Jan. 01, 2006 | A | Second |
| Jan. 10, 2006 | A | Second |
| Jan. 13, 2006 | A | Second |
| Jan. 14, 2006 | B | Third |
| Jan. 17, 2006 | B | Third |
| Jan. 20, 2006 | B | Third |

The data for Category A are divided according to the conventional method as shown in Table 2. Here, the data are simply divided according to the date (i.e., year, in this example) and the corresponding number of instances corresponding to Category A data occurring during that particular year. Thus, from Table 1, it can be seen that in the year 2003, there is a total of one instance corresponding to Category A (occurring on 01/01/2003). Again, with respect to Table 1, it can be seen that there are no Category A instances occurring in the year 2004, there is one Category A instance occurring in 2005 (occurring on 01/08/2005), and there are three Category A instances occurring in 2006 (occurring on 01/01/2006, 01/10/2006, and 01/13/2006). These values (i.e., number of instances) are provided in the second column in Table 2 for Category A data.

TABLE 2
Category A (Conventional Method)

| Date | Category A Instances |
|---|---|
| 2003 | 1 |
| 2004 | 0 |
| 2005 | 1 |
| 2006 | 3 |

The data for Category B are divided according to the conventional method as shown in Table 3. Similarly, from Table 1, it can be seen that in the year 2003, there are no instances corresponding to Category B data, there is one Category B instance occurring in the year 2004 (occurring on 01/05/2004), there are no Category B instances occurring in 2005, and there are three Category B instances occurring in 2006 (occurring on 01/14/2006, 01/17/2006, and 01/20/2006). These values (i.e., number of instances) are provided in the second column in Table 3 for Category B data.

TABLE 3
Category B (Conventional Method)

| Date | Category B Instances |
|---|---|
| 2003 | 0 |
| 2004 | 1 |
| 2005 | 0 |
| 2006 | 3 |

The data for Category A are divided according to the embodiments herein as shown in Table 4. Here, the total number of data elements in Table 1 corresponding to the data category type (i.e., Category A and Category B) are divided into different buckets (in this case, referred to as the first, second, and third bucket). In this case, there are a total of nine data elements. Thus, in order to create a substantially same number of data elements in each bucket, the data elements are divided by three, which becomes the number of buckets (i.e., first, second, third), wherein each bucket has a substantially same number of data elements contained therein (i.e., three data elements). Next, the data in the first bucket given in Table 1 are read. In the first bucket, there are two occurrences of Category A data (corresponding to 01/03/2003 and 01/08/2005). Similarly, in the second bucket, there are three occurrences of Category A data (corresponding to 01/01/2006, 01/10/2006, 01/13/2006). Finally, in the third bucket, there are no occurrences of Category A data.

TABLE 4
Category A (Invention)

| Bucket | Category A Instances |
|---|---|
| First | 2 |
| Second | 3 |
| Third | 0 |

The data for Category B are divided according to the embodiments herein as shown in Table 5. Similar to the process of dividing Category A data shown in Table 4, the data in the first bucket given in Table 1 are read in order to divide the Category B data. In the first bucket, there is one occurrence of Category B data (corresponding to 01/05/2004). Similarly, in the second bucket, there are no occurrences of Category B data. Finally, in the third bucket, there are three occurrences of Category B data (corresponding with 01/14/2006, 01/17/2006, and 01/20/2006).

TABLE 5
Category B (Invention)

| Bucket | Category B Instances |
|---|---|
| First | 1 |
| Second | 0 |
| Third | 3 |

Again, FIGS. 2(A) and 2(B) represent the conventional method of plotting data over time with the X-axis representing constant time. FIGS. 2(C) and 2(D) represent a method of plotting data according to the embodiments herein with time intervals made up of substantially N equal size buckets. Comparing FIGS. 2(A) and 2(C), the difference in Category A is dramatic, and shows that in FIG. 2(C) Category A data are actually decreasing in frequency over time as opposed to FIG. 2(A), which shows Category A data increasing in frequency over time.

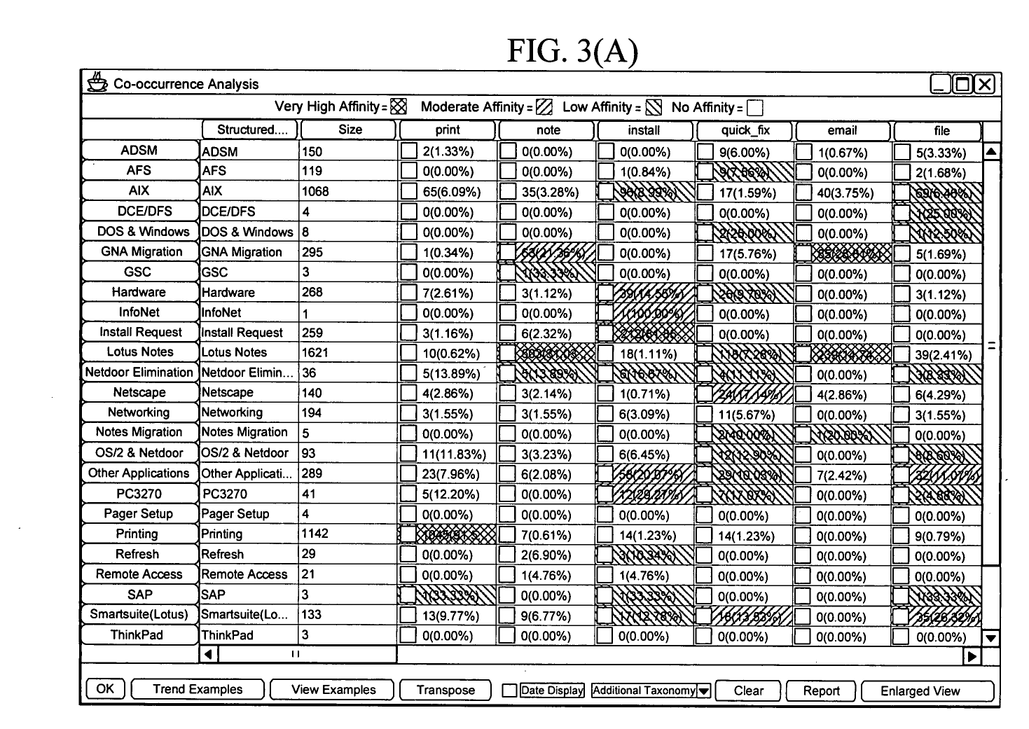

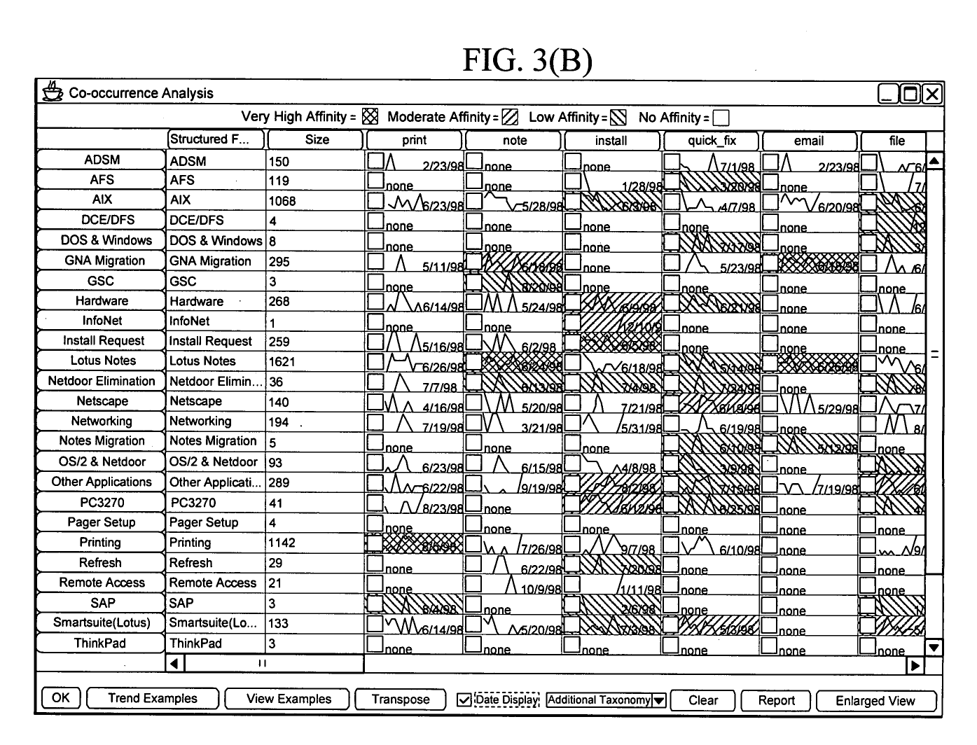

An example application according to the embodiments herein is as follows. The example begins with a set of “problem tickets” (e.g., telephone calls made to a help desk) that have been categorized in two different ways. One taxonomy is generated by text clustering and the other by human categorization. Generally, FIGS. 3(A) and 3(B) illustrate the embodiments herein in a before/after representation, respectively. In FIGS. 3(A) and 3(B), the “Size” column refers to the number of “problem tickets” in a specific human generated category. In FIG. 3(A), the numeric values in each cell represent the total number of problem tickets in each human generated category across each of the text clustering categories. In FIG. 3(B), each of these numeric values is replaced with a time summary created from that set of problem tickets.

More particularly, FIG. 3(A) illustrates a table showing a data set comprising data that are initially unevenly distributed with respect to a period of time in the set and have attributed data categories and dates. Thereafter, FIG. 3(B) illustrates the table after temporal summarization of the data set occurs by creating N different buckets in a hashing table, wherein each of the buckets comprises a substantially same number of data elements, wherein each of the data elements uniquely corresponds with a particular bucket, and wherein each of the buckets corresponds with a unique time period; and plotting, for each data category, a number corresponding to the number of data elements in the data category, as a function of the time periods corresponding to the N different buckets.

It is desired to visualize the intersection of each pair of categories in the two taxonomies over time. Using the time summarization provided by the embodiments herein, the table illustrated in FIG. 3(B) may be generated, wherein the table illustrated in FIG. 3(B) represents the result of several different summarization procedures in accordance with the embodiments herein. In this example, each cell of the table in FIG. 3(B) represents a subset of the data (in this case, problem tickets). More particularly, each cell of the table in FIG. 3(B) describes an output of the method of temporal summarization afforded by the embodiments herein.

The average date of that subset is displayed along with the trend line for that subset relative to the entire set of data. Using the average date, the cells can then be sorted in chronological order, by any column, in the manner of a standard spreadsheet program. While the average data value gives important information about how recent any particular subset is relative to other subsets, the line graph in each cell gives more specific information about how the data in each subset is distributed over time. Thus, two cells having the same average date might have very different distributions. Accordingly, the embodiments herein capture and communicate this significant information. FIG. 3(B) demonstrates how many different time based summaries may be combined into a single display showing how different categories of data relate to each other in time.

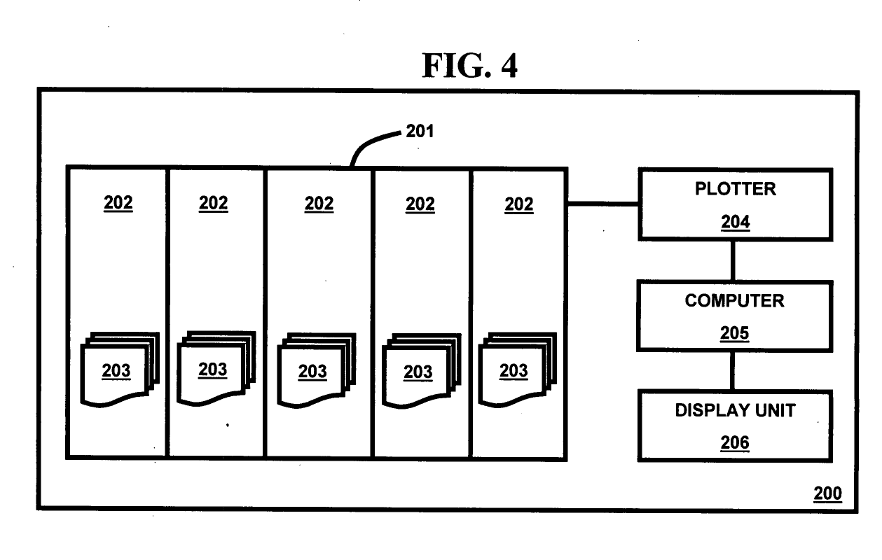

Another embodiment, as shown in FIG. 4, provides a relational database system 200 for temporal summarization of a data set comprising data that are initially unevenly distributed with respect to a period of time in the set and have attributed data categories and dates, wherein the relational database system 200 comprises a hashing table 201 comprising N number of different buckets 202, wherein each of the buckets 202 comprises a substantially same number of data elements 203, wherein each of the data elements 203 uniquely corresponds with a particular bucket 202, and wherein each of the buckets 202 corresponds with a unique time period.

The relational database system 200 further comprises a plotter 204 adapted to plot, for each data category, the number of data elements 203 corresponding with the data category as a function of a plurality of time periods defined by the N number of different buckets 202. Preferably, N is at least 3. Furthermore, the number of data elements 203 in the different buckets preferably differ from each other by no more than one. Preferably, the plotter 204 is adapted to plot respective line graphs corresponding to the plotted number of data elements 203, wherein each line graph corresponds with a particular data category.

Also, the relational database system 200 may further comprise a computer 205 adapted to compute a representative time for each of the data categories by calculating an average time of data elements 203 in a particular data category. Additionally, the relational database system 200 may further comprise a display unit 206 adapted to display, for at least one of the data categories, pairs of line graphs and corresponding representative times of the pairs of line graphs.

The embodiments herein can take the form of an entirely hardware embodiment, an entirely software embodiment or an embodiment including both hardware and software elements. Preferably, the embodiments are implemented in software, which includes but is not limited to firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

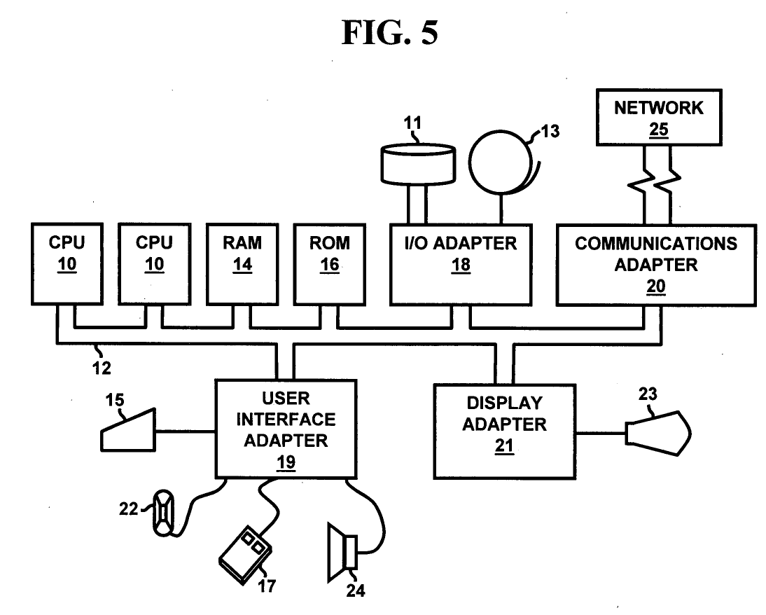

A representative hardware environment for practicing the embodiments herein is depicted in FIG. 5. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

For example, the embodiments may be implemented as a computer program, written in the Java® programming language and executed with a Java® virtual machine, both available from Sun Microsystems, California, USA. Although Java® code is used to implement the embodiments herein, those skilled in the art would readily understand that other programming languages and code descriptions could be used in accordance with the embodiments herein.

```
//this is a method to compute a single instance of a temporal
summarization of a subset
    MiniLineGraph compute Graph(Date D[ ], int N) {
        //D = original set, d = subset, N = buckets
        MiniLineGraph result = new MiniLineGraph(N);
        //the Index.run method produces an indexed ordering of the time
        stamps
        int order[ ] = Index.run(D);
        Long averageDate = 0
        For (int i=0; i<d.length; i++){
            avgDate+=D[d[i]].getTime( );
            //dpos represents the contiguous bucket that this time
            stamp falls in
    int dpos = findPosition(d[i],order[i]/N
    mlg.buckets[dpos]++;
}
//label the graph with the average date
mlg.finishGraph(df.format(new Date(avgDate)));
return(mlg);
}
public static int findPosition(int y, int x[ ]) {
for (int I=0; i<x.length; i++)
if (y==x[i] return(i);
return(−1);
}
public class MiniLineGraph extends JLabel {
int barheights[ ] = null;
float originals[ ] = null;
public int spacing = 0;
public String title = “ ”;
public int buckets[ ] = null;
public static int width = 95;
public static int height = 15;
public static int topmargin = 0;
public static int leftmargin = 0;
public int boxspace = 20;
public MiniLineGraph(int size) {
    buckets = new int[size];
    originals = new float[size];
}
public void finishGraph(string t) {
    title = t
    for (int i=0; i<originals.length; i++)
        originals[i] = buckets [i];
    spacing = width/originals.length;
    findbarheights(originals);
    setPreferredSize(new Dimension(width, height));
    set Text(“ ”);
//discovers the relative height of each point in the line graph
public void findbarheights(float bh[ ]) {
    float max =Util.maxf(bh)
    float min = Util.minf(bh)
    if (max==0.0F) {
    barheights = null;
    return;
}
int wholespace =height−2*topmargin;
double ratio − 1.0*(max−min)/(1.0*wholespace);
barheights =new int[bh.length];
for(int i=0; i<bh.length; i++) }
barheights[i] = (int)Math.round((bh[i]−min)/ratio);
}
}
public void paint(Graphics g) {
g.setColor(Color.black);
spacing=(width-slength-boxspace)/(barheights.length-1);
int indent=boxspace+spacing*(barheights.length-1);
g.drawString(title, indent, height-topmargin);
for (int i=0; i<barheights.length-1; i++) {
    drawLine(g,I,i+1);
}
}
//draws each of the lines between every two points in the graph
public void drawLine(Graphics g, int bar1, int bar2) {
int x1=bar 1*spacing+boxspace;
int x2=bar2*spacing+boxspace;
int barlength1=height-topmargin-barheights[bar1];
int barlength2=height-topmargin-barheights[bar2];
g.setColor(Color.black);
g.drawLine(x1, barlength1,x2,barlength2);
}
}
```

The embodiments provide a technique for summarizing category occurrence in taxonomies. The embodiments herein summarize temporal data by creating two distinct descriptive elements that complement each other. One is an “average” date that serves to anchor the data in time, and the second is a “relative” line graph that serves to show the overall relationship between the subset and the larger set over time. The combination of these two different metrics produces a powerful way to detect interesting temporal events in categorized data.

Time summarization can be used to discover emerging trends in categorized data. One example of how this might be used is in customer relationship management applications where one wishes to discover emerging customer trends or concerns and address them in a timely fashion. Another example is in tracking technology trends by mining patent data to see what new technologies are emerging in a given industry.

The embodiments herein are generally applicable to business intelligence processes, and in particular may be used in conjunction with techniques described in the following: U.S. Patent Application Publication No. 2005/0262039 entitled “Method and system for analyzing unstructured text in data warehouse;” U.S. Patent Application Publication No. 2002/0156810 entitled “Method and system for identifying relationships between text documents and structured variables pertaining to the text documents;” U.S. Pat. No. 6,725,217 entitled “Method and system for knowledge repository exploration and visualization;” and U.S. Pat. No. 6,100,901 “Method and apparatus for cluster exploration and visualization,” the complete disclosures of which, in their entireties, are herein incorporated by reference.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of temporal summarization of a data set comprising data that are initially unevenly distributed with respect to a period of time in said set and have attributed data categories and dates, said method comprising:
creating N different buckets in a hashing table, wherein each of said buckets comprises a substantially same number of data elements, wherein each of said data elements uniquely corresponds with a particular bucket, and wherein each of said buckets corresponds with a unique time period; and
plotting, for each data category, a number corresponding to the number of data elements in said data category, as a function of the time periods corresponding to the N different buckets.

2. The method of claim 1, further comprising plotting respective line graphs corresponding to the plotted number of data elements, wherein each line graph corresponds with a particular data category.

3. The method of claim 2, further comprising computing a representative time for each of said data categories by calculating an average time of data elements in a particular data category.

4. The method of claim 3, further comprising displaying, for at least one of said data categories, pairs of line graphs and corresponding representative times of said pairs of line graphs.

5. The method of claim 1, wherein N is at least 3.

6. The method of claim 1, wherein the number of data elements in the different buckets differ from each other by no more than one.

7. A method of performing temporal summarization of a data set comprising timestamps corresponding to dates of data elements in said data set, said method comprising:
sorting said timestamps in chronological order;
dividing said timestamps into N contiguous buckets of substantially equal size;
counting, for each of said N contiguous buckets, how many data elements belong to a particular bucket;
calculating an average date of said data elements in said data set;
plotting numeric values corresponding to said data elements in each of said N contiguous buckets; and
combining the calculated average date and the plotted numeric values to describe said data set.

8. The method of claim 7, further comprising plotting respective line graphs corresponding to the plotted numeric values, wherein each line graph corresponds with a particular data set.

9. The method of claim 8, further comprising computing a representative time for each said data set by calculating an average time of said data elements corresponding with a particular data set.

10. The method of claim 9, further comprising displaying, for at least one of said data sets, pairs of said line graphs and corresponding representative times of said pairs of said line graphs.

11. The method of claim 7, wherein N is at least 3.

12. The method of claim 7, wherein said substantially equal size comprises a substantially same number of data elements in different ones of said N contiguous buckets, wherein the number of data elements in the different buckets differ from each other by no more than one.

13. A relational database system for temporal summarization of a data set comprising data that are initially unevenly distributed with respect to a period of time in said set and have attributed data categories and dates, said relational database system comprising:
a hashing table comprising N number of different buckets, wherein each of said buckets comprises a substantially same number of data elements, wherein each of said data elements uniquely corresponds with a particular bucket, and wherein each of said buckets corresponds with a unique time period; and
a plotter adapted to plot, for each data category, said number of data elements corresponding with said data category as a function of a plurality of time periods defined by said N number of different buckets.

14. The relational database system of claim 13, wherein said plotter is adapted to plot respective line graphs corresponding to the plotted number of data elements, wherein each line graph corresponds with a particular data category.

15. The relational database system of claim 14, further comprising a computer adapted to compute a representative time for each of said data categories by calculating an average time of data elements in a particular data category.

16. The relational database system of claim 15, further comprising a display unit adapted to display, for at least one of said data categories, pairs of line graphs and corresponding representative times of said pairs of line graphs.

17. The relational database system of claim 13, wherein N is at least 3.

18. The relational database system of claim 13, wherein the number of data elements in the different buckets differ from each other by no more than one.

19. A program storage device readable by computer, tangibly embodying a program of instructions executable by said computer to perform a method of temporal summarization of a data set comprising data that are initially unevenly distributed with respect to a period of time in said set and have attributed data categories and dates, said method comprising:
creating N different buckets in a hashing table, wherein each of said buckets comprises a substantially same number of data elements, wherein each of said data elements uniquely corresponds with a particular bucket, and wherein each of said buckets corresponds with a unique time period; and
plotting, for each data category, a number corresponding to the number of data elements in said data category, as a function of the time periods corresponding to the N different buckets.

20. The program storage device of claim 19, wherein said method further comprises plotting respective line graphs corresponding to the plotted number of data elements, wherein each line graph corresponds with a particular data category.

21. The program storage device of claim 20, wherein said method further comprises computing a representative time for each of said data categories by calculating an average time of data elements in a particular data category.

22. The program storage device of claim 21, wherein said method further comprises displaying, for at least one of said data categories, pairs of line graphs and corresponding representative times of said pairs of line graphs.

23. The program storage device of claim 19, wherein N is at least 3.

24. The program storage device of claim 19, wherein the number of data elements in the different buckets differ from each other by no more than one.
